(19) United States
(12) Patent Application Publication
(10) Pub. No.: US 2009/0005510 A1
(43) Pub. Date: Jan. 1, 2009

(54) Aramid fiber reinforcement for elastomeric products

(76) Inventor: Benjamin J. Kwitek, Canon City, CO (US)

Correspondence Address: WELSH & FLAXMAN LLC, 2000 DUKE STREET, SUITE 100, ALEXANDRIA, VA, 22314, US

(21) Appl. No.: 12/216,174

(22) Filed: Jun. 30, 2008

Related U.S. Application Data
(60) Provisional application No. 60/929,479, filed on Jun. 29, 2007.

(51) Int. Cl. C08F 283/00; C08L 67/00

(52) U.S. Cl. 525/190; 525/418

(57) ABSTRACT

A user conformable composition includes a soft elastomer compound and a filler composed of aramid fibers, wherein the aramid fibers are fibrillated and dispersed in a base polymer, the base polymer/fibrillated aramid fibers being mixed with the soft elastomer compound. The compound is manufactured by fibrillating raw aramid fiber to create fibrillated aramid fibers, dispersing the fibrillated aramid fibers within a base polymer to create small pieces, mixing the small pieces into a soft elastomer compound.

### CROSS REFERENCE TO RELATED APPLICATION

This application claims the benefit of U.S. Provisional Patent Application Ser. No. 60/929,479, entitled “ARAMID FIBER REINFORCEMENT FOR ELASTOMERIC PRODUCTS”, filed Jun. 29, 2007.

### BACKGROUND OF THE INVENTION

1. Field of the Invention

The invention relates to the creation of a composition useful in soft touch and comfort products. More particularly, the invention relates to a user engagable surface composition composed of elastomers and aramid fibers, such as, Kevlar. This composition provides advantages for various consumer, business and industrial products.

2. Description of the Related Art

Everywhere people turn, they encounter unfriendly surfaces. From grabbing a door handle to wearing shoes, the interface between the user and various devices, implements, machines and equipment is essential. One cannot play golf without gripping the club or drive a car without holding the steering wheel.

For centuries, people have tried to improve the comfort offered by such products. Prior to the development of engineered materials, product comfort was improved by utilizing materials such as leather (in the 1800s) or rubber (in the 1900s). With the development of material science engineering, many materials have been introduced that help the user interact more comfortably with devices, implements or machines.

Our modern economy has produced unprecedented wealth among millions of people around the world and opened a global community. As a result, people are more aware of product design than ever. The Internet and modern technology has allowed people anywhere to witness the best products from other nations; whether Italy, Germany, Japan or countless other states. People are demanding products that suit their lifestyles. Comfort, quality and durability are mainstays for this trend.

As mentioned above, various attempts have been made to improve the comfort level afforded by interactive products available in the market place. Most currently available soft touch and comfort products exhibit problems with regards to strength and durability. This emphasis can clearly be seen and felt in the market. Most products are only mildly comfortable. Perhaps better than metal, the hard rubber grips on a bicycle or a lawn mower are not exactly innovative. Other products also suffer in this area. Most portable electronic devices are made from metals and hard plastics. These materials do not support effective and healthy use. While sometimes comfortable, the soles of shoes, for example, may not sustain the durability the user or even the manufacture would prefer.

It is commonly observed soft and strong properties within a composition are generally opposed to one another. A piece of fluffy cotton is very soft, but it is so weak that it can literally be blown into pieces with a deep breath. On the contrary, an ingot of steel is very strong, but it would never be described as soft. Generally, soft things are weak and strong things are hard. This presents a major problem for products involving human interaction. What if people require a product that is soft and strong? Today more consumers are demanding soft products, that is, those that are comfortable, ergonomic and fun to use, although consumers want strength and durability in these new products.

As a result, a recurring problem exists. The softer a chemist designs a thermoplastic or thermoset material, the weaker it becomes. The chemistry virtually guarantees this outcome. The softest plastics and gels are very comfortable and friendly. Unfortunately, these materials are susceptible to damage and destruction in our harsh environment.

A need, therefore, exists for new materials offering both softness and durability. The present invention provides such a material and the applications or products that employ its technology.

### SUMMARY OF THE INVENTION

It is, therefore, an object of the present invention to provide a user conformable composition comprising a soft elastomer compound and a filler composed of aramid fibers, wherein the aramid fibers are fibrillated and dispersed in a base polymer, the base polymer/fibrillated aramid fibers being mixed with the soft elastomer compound.

It is also an object of the present invention to provide a method for forming a composition comprising the steps of fibrillating raw aramid fiber to create fibrillated aramid fibers, dispersing the fibrillated aramid fibers within a base polymer to create small pieces, mixing the small pieces into a soft elastomer compound.

It is a further object of the present invention to provide a composition formed by the method comprising the steps of fibrillating raw aramid fiber to create fibrillated aramid fibers, dispersing the fibrillated aramid fibers within a base polymer to create small pieces and mixing the small pieces into a soft elastomer compound.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of a basic aramid fiber.

FIG. 2 is a schematic of a fibrillated aramid fiber.

FIG. 3 shows a cross sectional schematic of a polymer piece with dispersed, fibrillated aramid fiber.

FIG. 4 shows a cross sectional schematic of an elastomer in accordance with the present invention with the fibrillated aramid fiber.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

In accordance with the present invention, a user conformable composition is provided which provides both soft and strong characteristics in a balanced manner. Soft and strong are terms that have both objective and subjective meanings. Both are important for the preferred embodiments. An objective measure of soft is the Shore A Durometer Scale. This scale ranges from 0 to 100 in most applications. The lower the number, the softer the material is considered to be. In accordance with the present invention, the present composition generally has a Shore A Durometer measurement of less than 50 and is considered to be “soft”.

Similar to soft, strength has some objective measures. These include tensile strength, tear strength, elongation, abrasion resistance, compression and modulus. These measures are sanctioned by the ASTM (American Society for Testing and Materials). For example, for a very soft elastomer a common tensile strength might be 125-175 psi. The tear strength of this same material might be 25-50 lb·f/in. Elongation might be 500-700 percent and modulus might be 40-70 psi. For abrasion resistance, baseline numbers can only be understood in the context of the application and the ASTM methodolgy. The present invention discloses a composition that employs two or more materials that are seemingly unrelated. When combined in the creation of the present composition, these materials provide a soft surface exhibiting desirable strength characteristics. Consequently, the previously listed ranges increase, showing the improved strength of the new material and products.

In particular, soft plastics and elastomeric materials are modified through the addition of a filler. In accordance with a preferred embodiment, the soft plastics and elastomeric materials are thermoset or thermoplastic elastomers. More particularly, the thermoset or thermoplastic elastomers used in accordance with the present invention are selected from styrenic block copolymers, polyolefin blends, elastomeric alloys, polyurethanes, copolyesters and polyamides. In addition to the thermoplastic elastomers, it is contemplated some thermoset materials, such as, natural and synthetic rubber and silicone, may be used within the spirit of the present invention.

In accordance with a preferred embodiment, the filler is an aramid fiber, such as, KEVLAR, which is manufactured by the E.I. duPont de Nemours & Company. It has been found the addition of KEVLAR to the elastomeric material may produce dramatic improvements in strength. These measures of strength correspond to those mentioned previously. For example, with the aramid fiber reinforcement, tear strength may increase 15% or more; tensile strength, abrasion resistance may increase 30% or more; modulus and other measures of strength may increase 50% or more. Where the base material is very soft, the KEVLAR enhances its strength while not adversely affecting the soft, flexible and comfortable features of the material.

As those skilled in the art will certainly appreciate, KEVLAR is made from aramid strands or fibers. These fibers are sized in various ways. In its native state, and accounting for weight, KEVLAR is five times stronger than steel. For many applications, such as bullet-resistant vests, the fibers are woven into protective cloth or fabric. Although certainly strong in their native state, the KEVLAR fibers gain additional strength from their placement within the fabric. As those skilled in the art will appreciate, the process of incorporating thousands or millions of lose fibers into a solid or semi-solid plastic or elastomer is difficult. The fibers tend to clump and disperse unevenly. This unequal mixture makes effective strength engineering impossible. The present invention utilizes a multi-step process to achieve the desired strength goals within a soft plastic or elastomeric material.

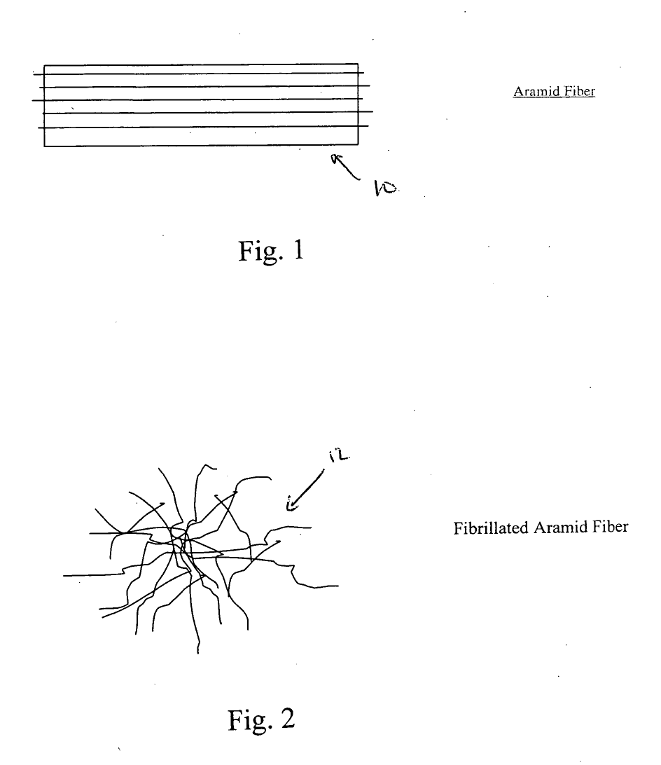

The raw aramid fibers 10 (see FIG. 1) are first fibrillated to created fibrillated aramid fibers 12 (see FIG. 2). The raw aramid fibers 10 are generally less than approximately 5 mm in length and approximately 2 mm in width. The aramid fibers are fibrillated to increase the surface area of the aramid fibers and improve adhesion to the base plastic or elastomer. The process is similar to fraying the end of a rope before dipping it into paint. As a result, the frayed ends of the fibrillated aramid fibers 12 may be covered with a polymer (as discussed below) adding greater surface area coverage to the fibrillated aramid fibers 12. In fact, and in accordance with a preferred embodiment of the present invention, the fibrillation process increases surface area of the aramid fibers from approximately 0.1 m²/gram to approximately 8.0 m²/gram or more.

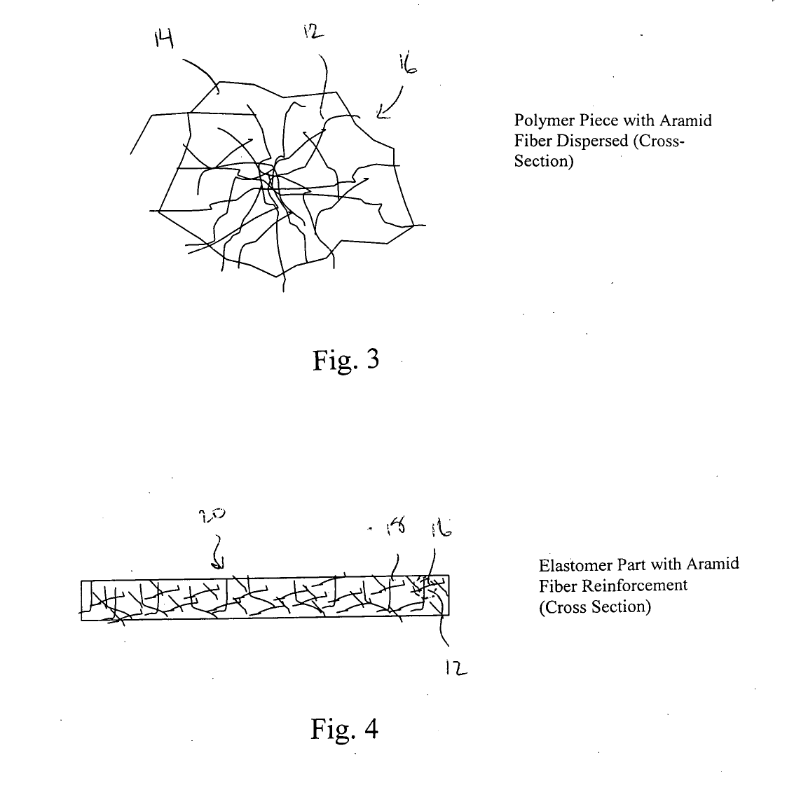

Referring to FIG. 3, the second step in the process involves dispersing the fibrillated aramid fibers 12 within a base polymer 14. In accordance with a preferred embodiment, the base polymer 14 is a thermoplastic material (for example, styrenic block copolymers, polyolefin blends (such as ENGAGE, which is manufactured by E.I. duPont de Nemours & Company), elastomeric alloys, polyurethanes, copolyesters and polyamides). In addition to thermoplastics, it is contemplated some thermoset materials, such as, natural and synthetic rubber and silicone, may be used within the spirit of the present invention.

Through advanced extrusion, injection molding and other processes familiar to those in the art, the frayed, fibrillated aramid fibers 12 are evenly mixed into the liquid or semi-liquid base polymer 14. The temperature range for this processing is between approximately 100° C. and approximately 400° C. The lapsed time intervals depend on the specific materials, concentrations and desired outcomes. The concentration of fibrillated aramid fibers 12 within the base polymer 14 is very high, for example, greater than approximately 30 percent. Once the fibrillated aramid fibers 12 are incorporated within the base polymer 14, it is extruded into small pieces 16. In accordance with a preferred embodiment, these small pieces 16 are approximately 3 cm×3 cm×3 cm, or smaller, and more preferably, approximately 1.5 cm×1.5 cm×1.5 cm, or less.

Referring to FIG. 4, the small pieces 16 are then mixed into a soft elastomer compound 18. In accordance with a preferred embodiment, the soft elastomer compound 18 is a thermoplastic or thermoset material selected from styrenic block copolymers, polyolefin blends, elastomeric alloys, polyurethanes, copolyesters, polyamides, natural and synthetic rubbers, EPDM (“Ethylene-Propylene-Diene-Monomer”), and silicones.

In accordance with a preferred embodiment, the small pieces 16 are mixed with the soft elastomer compound 18 via extrusion. Extrusion is preferably achieved through the utilization of a twin-screw extrusion machine. A co-rotating machine with an approximately 30 mm or greater diameter is preferred. The processing temperatures range from approximately 175° C. to approximately 250° C. As those skilled in the art will certainly appreciate, the time and speed associated with processing will depend on the specific material mix and desired outcome.

The hardness of the two materials is important. The base polymer 14 with the fibrillated aramid fibers 12, that is, KEVLAR in accordance with a preferred embodiment, added is quite firm. Its Shore A Durometer Hardness is more than approximately 50. The soft elastomer compound 18 has a very low Shore A Durometer hardness. In accordance with a preferred embodiment, it is between approximately 5 and approximately 40. In this way, the soft elastomer compound 18 counters the hardness of the fibrillated aramid fibers 12/base polymer 14 mixture, which has the high fibrillated aramid fiber 12 (KEVLAR) concentrations.

Once the fibrillated aramid fiber 12/base polymer 14 compound and the soft elastomer compound 18 are joined, the materials are extruded and are processed into small pellets, balls or pieces 20. The small pellets, balls or pieces 20 are less than approximately 75 mm in diameter and, more preferably, are less than approximately 30 mm in diameter. These pieces 20 are then extruded, injection-molded or otherwise developed into a variety of elastomeric products. Give the strength of fibrillated aramid fibers 12 and the processing steps, the final percentage of fibrillated aramid fibers 12 within the final elastomer composition may be quite low, likely less than approximately 25 percent and perhaps as low as 1 percent or less.

Although KEVLAR is disclosed in accordance with a preferred embodiment as a preferred aramid fiber for use in accordance with the present invention, various other filler materials may be mixed or combined with the elastomers to provide ergonomic and functional benefits. These may include carbon fibers, glass fibers, natural fiber and other engineered products. In fact, even on a molecular scale, two or more material may be combined to produce desired results. An emphasis on Nanotechnology might be appropriate. The resulting material may be implemented in any product, device implement or machine that is subject to human interaction. When taken together, two ore more materials can make previous challenges disappear. The two or more materials may exist independently but can be engineered side by side or may be mixed to form one material with the appropriate features.

The benefits of this combination of a soft elastomer and an aramid fiber (KEVLAR) reinforced polymer are significant. The overall strength increases and can be measured by tear strength and tensile strength. The durability, or strength over time, is also greatly enhanced. This can be quantified via abrasion testing and other practical or real-world environmental evaluations.

The present invention also provides for the use of this soft and strong material in various applications. Most of these end-use applications or products related to human-machine, human-implement or human-environment interactions. It is in these applications where ergonomics and comfort are desired but where strength and durability are also demanded.

In practice, it is contemplated the present material may be utilized, but not limited to use, in devices such as shoes or foot care aids (for example, soles, outer and inner shoes, cushions and injury treatment), industrial equipment and surfaces (for example, handles and wear surfaces), medical devices and products (for example, handles or grips, equipment surfaces, cushions and injury treatment), sporting goods (for example, golf, tennis, baseball, hockey and football), automotive materials and products (for example, steering wheels, soft components, floor mats and tires), furniture products (for example, cushions and foot protectors), aviation products (for example, handles, components and wear surfaces), military products and applications (for example, handles, machines, safety equipment and wear surfaces), boat and/or watercraft products (for example, handles/controls, cushions and wear surfaces), electronic and computing devices (for example, corner guards, soft touch surfaces and vibration dampening), clothing and apparel (for example, padding and wear surfaces), hand and power tools (for example, grips and handles), floor coverings (for example, carpets, mats and composite materials) and household or domestic goods (for example, kitchen appliances, bathroom tools and personal hygiene).

While the preferred embodiments have been shown and described, it will be understood that there is no intent to limit the invention by such disclosure, but rather, is intended to cover all modifications and alternate constructions falling within the spirit and scope of the invention.

1. A user conformable composition, comprising:
a soft elastomer compound;
a filler composed of aramid fibers, wherein the aramid fibers are fibrillated and dispersed in a base polymer, the base polymer/fibrillated aramid fibers being mixed with the soft elastomer compound.

2. The composition according to claim 1, wherein the soft elastomer compound is a thermoplastic material or a thermoset material.

3. The composition according to claim 2, wherein the soft elastomer compound is selected from the group consisting of styrenic block copolymers, polyolefin blends, elastomeric alloys, polyurethanes, copolyesters, polyamides, natural and synthetic rubbers, EPDM, and silicones.

4. The composition of claim 1, wherein the composition is incorporated into a soft and strong consumer, industrial or military product.

5. A method for forming a composition, comprising:
fibrillating raw aramid fibers to create fibrillated aramid fibers;
dispersing the fibrillated aramid fibers within a base polymer to create small pieces; and
mixing the small pieces into a soft elastomer compound.

6. The method according to claim 5, wherein the raw aramid fibers are less than approximately 5 mm in length and approximately 2 mm in width.

7. The method according to claim 5, wherein the step of fibrillating increases the surface area of the raw aramid fibers from approximately 0.1 m²/gram to approximately 8.0 m²/gram or more.

8. The method according to claim 5, wherein the base polymer is a thermoplastic material.

9. The method according to claim 5, wherein the step of dispersing includes processing the fibrillated aramid fibers and the base polymer at a temperature from between approximately 100° C. and approximately 400° C.

10. The method according to claim 5, wherein the small pieces are approximately 3 cm×3 cm×3 cm, or smaller.

11. The method according to claim 10, wherein the small pieces are approximately 1.5 cm×1.5 cm×1.5 cm, or less.

12. The method according to claim 5, wherein the soft elastomer compound is selected from the group consisting of styrenic block copolymers, polyolefin blends, elastomeric alloys, polyurethanes, copolyesters, polyamides, natural and synthetic rubbers, EPDM, and silicones.

13. A composition formed by the method comprising the following steps:
fibrillating raw aramid fibers to create fibrillated aramid fibers;
dispersing the fibrillated aramid fibers within a base polymer to create small pieces;
mixing the small pieces into a soft elastomer compound.

14. The composition according to claim 13, wherein the raw aramid fibers are less than approximately 5 mm in length and approximately 2 mm in width.

15. The composition according to claim 13, wherein the step of fibrillating increases the surface area of the raw aramid fibers from approximately 0.1 m²/gram to approximately 8.0 m²/gram or more.

16. The composition according to claim 13, wherein the base polymer is a thermoplastic material.

17. The composition according to claim 13, wherein the step of dispersing includes processing the fibrillated aramid fibers and the base polymer at a temperature from between approximately 100° C. and approximately 400° C.

18. The composition according to claim 13, wherein the small pieces are approximately 3 cm×3 cm×3 cm, or smaller.

19. The composition according to claim 18, wherein the small pieces are approximately 1.5 cm×1.5 cm×1.5 cm, or less.

20. The composition according to claim 13, wherein the soft elastomer compound is selected from the group consisting of styrenic block copolymers, polyolefin blends, elastomeric alloys, polyurethanes, copolyesters, polyamides, natural and synthetic rubbers, EPDM, and silicones.
